(19) United States
(12) Patent Application Publication
(10) Pub. No.: US 2024/0396374 A1
(43) Pub. Date: Nov. 28, 2024

(54) Wireless Charger Device and the System of the Same

(71) Applicant: Metaone Corporation, Taipei City (TW)

(72) Inventors: Kuo-Ching CHIANG, New Taipei City (TW); Yueh-Feng CHIANG, Taipei City (TW)

(21) Appl. No.: 18/671,316

(22) Filed: May 22, 2024

(30) Foreign Application Priority Data
May 22, 2023 (TW) 112119233
May 30, 2023 (TW) 112120492
Jun. 26, 2023 (TW) 112123995

(51) Int. Cl. H02J 50/12; B60L 53/12; B60L 53/37; B60L 53/38; H02J 50/40; H02J 50/90

(52) U.S. Cl. CPC H02J 50/12; B60L 53/12; B60L 53/37; B60L 53/38; H02J 50/402; H02J 50/90

(57) ABSTRACT

A wireless charging device includes a wireless communication device configurated in the wireless charging device to communicate with an electric vehicle. At least one transmitting coil is connected to a power supply to wirelessly charge the electric vehicle, and at least one resonant coil is configurated in front of the at least one transmitting coil to form a negative or zero refractive index medium by resonance.

### TECHNICAL FIELD

The present invention relates to charging device, more specifically, a wireless charging device with resonators.

### BACKGROUND

Portable electronic devices, for example, mobile phones and tablets usually employ rechargeable batteries to provide power. Typically, it is recharged by wires. The rechargeable batteries are charged inductively as well, the charging coils are located in the charger base while the receiving coils are located in the device to be charged. When the power is applied to the charger, current flows through the coil, thereby creating magnetic flux. When the receiving coil of the device is placed close to the transmitting coil, the current induced in the receiving coil charges the battery installed in the device.

In a typical wireless charging system, the transmitter system uses alternating current to drive the coil and generate magnetic field at the coil. If the receiving coil is placed close enough to the transmitting coil, the current is induced in the receiving coil according to Faraday's law. By adjusting the current in the transmitting coil and the load in the receiving coil, the transmitter and receiver transmit data in the magnetic field.

However, at present, no matter it is transmission coils or receiving coils, the generated magnetic flux distribution is not uniform, and it might be divergent magnetic fields. Therefore, the wireless charging efficiency is poor, and it must be placed close enough to the charging device, the charging distance is unlikely to lengthen. In view of above deficiencies, the present invention proposes an improved wireless charging device.

### SUMMARY OF THE INVENTION

Based on above, the purpose of the present invention is to provide a wireless charging device, which includes a power interface; a transmitting coil coupled to the power source through the power interface. A magnetic field convergence device is disposed in front of or in the near field (side) of the transmitting coil. The medium with negative or zero refractive index can be formed by resonance. The magnetic field converging device includes a resonator array, and the resonator array includes a split ring resonator array, a straight wire array, or the combination thereof. In another embodiment, the resonator array includes a spiral coil resonator array.

The present invention discloses a wireless charging device including a battery; a receiving coil is coupled to the battery. A magnetic field converging device is disposed in the front end of the receiving coil or in the near field (or side). The magnetic field converging device includes a resonator array, and the resonator array includes a split ring resonator array, a straight wire array, or the combination thereof. In another embodiment, the resonator array includes a spiral coil resonator array.

In one aspect, the present invention discloses a wireless charging device including a transmitting coil, which is configured in a rectangular shape and can be coupled to a power source through a power interface. A magnetic field converging device includes a plurality of spiral coils disposed inside the transmitting coil as resonators, the magnetic field converging device forms the negative or zero refractive index material. The radius of the spiral coil is R, the distance between adjacent spiral coils is d, and the ratio d/R is less than 10%.

The present invention discloses a wirelessly charged device under charging, it includes a receiving coil configured in a rectangular shape to generate electromagnetic induction current; a magnetic field convergence device includes a plurality of spiral coils arranged inside the receiving coil as a resonator, wherein the magnetic field convergence device is an equivalent medium with a negative or zero refractive index; the wirelessly charged device includes a mobile electronic device, a gasoline-electric hybrid vehicle, or an electric vehicle. The radius of the spiral coil is R, the distance between adjacent spiral coils is d, and the ratio d/R is less than 10%.

A wireless charging system includes a wireless charging device. The wireless charging device has a transmitting coil and a first magnetic field converging device, which is arranged at the front end of the transmitting coil or in the near field. The first magnetic field converging device generates a negative or zero refractive index equivalent medium by resonance. The wireless charged device includes a receiving coil, which corresponds to the transmitting coil to generate an induced current; the wireless charged device includes a mobile electronic device, a hybrid electric vehicle, or an electric vehicle. The wireless charged device includes a second magnetic field converging device, which is disposed at the front end of the receiving coil or in the near field, wherein the second magnetic field converging device forms the equivalent medium with a negative or zero refractive index. The first or second magnetic field converging device includes a split ring resonator array or a spiral coil resonator array.

A wireless charging device includes a power interface for connecting to the power source. At least one transmitting spiral coil is coupled to the power source through the power interface; and at least one resonant spiral coil is configured in front of the at least one transmitting spiral coil, and the resonant spiral coil is not coupled with any power source. The resonant spiral coil can form an equivalent medium with a negative or zero refractive index, and the at least one transmitting spiral coil has the same structure with the at least one resonant spiral coil.

A wireless charged device includes a battery; a receiving coil is coupled to the battery; and a magnetic field convergence device is located at the front end or side of the receiving coil, wherein the magnetic field convergence device forms the negative or zero refractive index medium; wherein the magnetic field converging device includes a resonator, a straight wire, or the combination thereof. The resonator includes a ring or a coil, and the wireless charged device is configured in the electric vehicle.

A wireless charging device includes a coil coupled to a power source; a magnetic field convergence device includes a resonator array, which is disposed at the front end of the transmitting coil to form a stacked structure, wherein the magnetic field convergence device forms the negative or zero refractive index medium (meta material), where the resonator array contains the spiral coil or the split ring.

A wireless charging device includes a power interface for connecting to a power source; the transmitting coil is coupled to the power source through the power interface and the transmitting coil includes at least one planar rectangular or square coil, which is arranged on a substrate. A magnetic field converging device is arranged in front of or side of the transmitting coil, wherein the magnetic field converging device can form an equivalent medium with the negative or zero refractive index; wherein the magnetic field converging device includes the split ring or the spiral coil or the combination thereof.

A wireless charging system includes a processing unit; a wireless communication unit is electrically coupled to the processing unit to communicate with the electric vehicle; the wireless charger is electrically coupled to the processing unit, wherein the wireless charger contains a magnetic field converging device, wherein the magnetic field converging device forms the negative or zero refractive index medium to wirelessly charge the electric vehicle. It includes a rate calculation unit, an error detection unit or the combination thereof, wherein the wireless charger includes a resonator array, which is arranged at the front end of the transmitting coil or in the near field of the transmitting coil, and the resonator array forms the negative or zero refractive index material. The resonator arrays include split ring or coil resonators.

### BRIEF DESCRIPTION OF THE DRAWINGS

FIG. 1 shows the charging functional diagram according to the present invention.

FIG. 2 shows the refraction of positive and zero refractive index materials.

FIG. 3 shows the schematic diagram of the magnetic flux convergence device according to the present invention.

FIG. 4 shows the schematic diagram of the magnetic flux convergence device according to the present invention.

FIG. 5 shows the schematic diagram of the resonator according to the present invention.

FIG. 6 shows the schematic diagram of the resonator array layer and wire array layer according to the present invention.

FIG. 7 shows the functional diagram of transmitter and receiver according to one embodiment of the present invention.

FIG. 8 shows the top view of the transmitter of the present invention.

FIG. 8A shows the transmitter of the present invention.

FIG. 8B shows the transmitter of the present invention.

FIG. 8C shows the transmitter array of the present invention.

FIG. 8D shows the transmitter, resonator of the present invention.

FIG. 9 shows the receiver over the transmitter.

FIG. 10 shows the receiver over the transmitter.

FIG. 11 shows the functional diagram of the present invention.

FIG. 12 shows the wireless charging system of the present invention.

FIG. 13 shows the wireless charging system of the present invention.

FIG. 14 shows the wireless charging system of the present invention.

FIG. 15 is the flow chart of forming the antenna.

FIG. 16 shows electromagnetic wave converging device and the antenna of the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

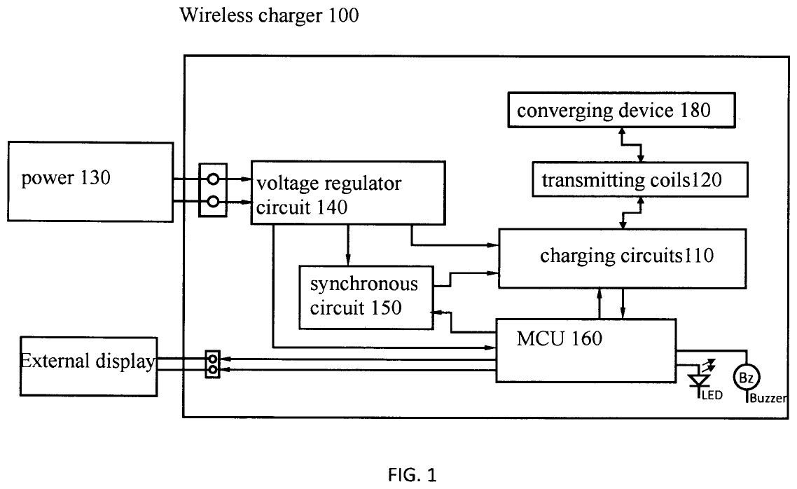

FIG. 1 shows the block diagram of a wireless charger 100 according to one preferred embodiment of the present invention. The wireless charging device 100 of the present invention includes a housing for accommodating electronic components, such as a circuit board (PCB) and a transmitting coil of the wireless charger 100. The wireless charger 100 includes a transmitting component, namely transmitting coils 120, connected to the wireless charging circuit 110 for wirelessly transmitting power to a receiving component of the mobile device. A shielding layer is placed between the transmitting coils 120 and the PCB to shield the electromagnetic field generated during wireless power transmission. The wireless charging circuit 110 is used to energize the transmitting coil 120 to wirelessly charge the rechargeable mobile device with built-in wireless charging function. The wireless charging circuit 110 supplies power from the power supply 130 through wires.

As shown in FIG. 1, the wireless charging device 100 includes a wireless charging circuit 110. The wireless charging circuit 110 is configured correspondingly to the transmitting coils 120. It is powered by the power supply 130 through the voltage regulator circuit 140. The wireless charging circuit 110, the synchronous circuit 150 and microcontroller unit (MUC) 160 are coupled to the power supply 130 by voltage regulator circuit 140. The microcontroller unit 160 controls the synchronous circuit 150 to drive the voltage regulator circuit 140 to provide appropriate power to the transmitting coil 120 for charging.

Generally, in order to optimize the charging efficiency of the wireless charger 100, the transmitting coils 120 are configurated to align with the receiving device of the rechargeable mobile device, for example, the Qi® wireless charging solution. In the wireless communication protocol, a nearby receiver, i.e. the receiving unit of the mobile device to be charged, will check the transmitter (sending party), send back data and identify the transmitter device. The connection between the transmitter (the charger's coils) and receiver (the mobile device's receiving device) is thereafter established. If none of the communication protocols satisfy the demand, the wireless charger device 100 will continue scanning. If the charging coils detect the matched protocol, the MCU 160 controls the synchronous circuit 150 to drive the voltage regulator circuit 140 to provide power to the coils for charging the mobile device. In addition, the wireless charger 100 also has optional features, such as LED indication or a buzzer, to inform the charging status. The above certification, communication and matching steps are also applied to Qi® or SAEJ2954.

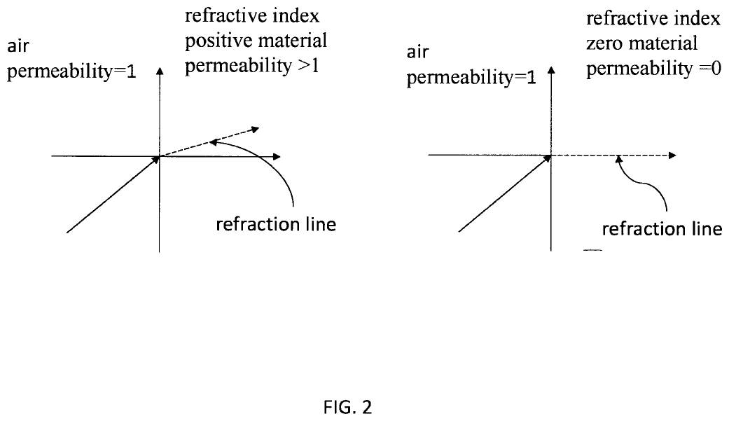

Space mapping is derived from coordinate transformation, which shows that electromagnetic fields can be manipulated, see Pendry, J. B., D. Schurig, and D. R. Smith, “Controlling electromagnetic fields,” Science, Vol. 312, 1780, 2006. The spatial transformations can be applied from optical to all frequencies. As mentioned above, the prior art causes divergent light. Therefore, the present invention configures a light bending element, such as a lens, at the front end of the lens set to condense the divergent light (electromagnetic waves). Refer to the left side of FIG. 2. Generally, the transmission of light from air into materials follows the right-hand rule, and its refractive index is positive, thus causing light (electromagnetic waves) to diverge. If the medium's permittivity (ε=ε₀εᵣ) or permeability (μ=μ₀μᵣ) is zero (or approaches zero), its refractive index approaches 0, which is a zero-refractive index material. If the medium's permittivity or permeability is negative, it refers to negative refractive index material (meta material). The refractive index of the negative-index material for an electromagnetic wave is a negative value over some frequency range. For plane waves propagating in electromagnetic metamaterials, the electric field, magnetic field and wave vector follow a left-hand rule, the reverse of the behavior of conventional optical material. See the right side of FIG. 2. In optics, the refractive index (or refraction index) of an optical medium is a dimensionless number that gives the indication of the light bending ability of that medium. The refractive index can be seen as the factor by which the speed and the wavelength of the radiation are reduced with respect to their vacuum values. The refractive index is proportional to the root of the product of ε and μ. For most materials, the permittivity and permeability are positive values, while the permittivity of plasma is negative, and the permeability of ferrite is negative. In 2009 Plum, E et al. proposed the properties of negative refractive index materials, see Physical Review B. 79 (3):035407.

At the interface between zero refractive index material and free space, no matter what incident angle the electromagnetic wave incidents on the zero refractive index material (or negative refractive index material), the incident light is bend to nearly parallel to the normal line of the interface. Arranging the zero refractive index material in the front or near field of the coils can effectively concentrate the magnetic flux, thereby improving the directionality and gain of the magnetic flux, thereby improving charging efficiency.

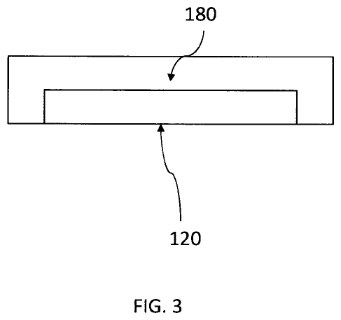

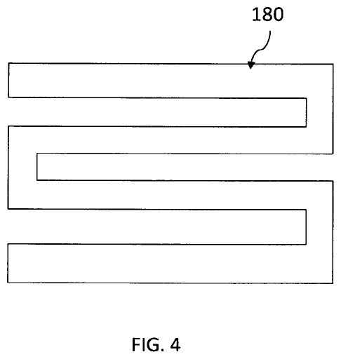

Referring to FIG. 1, the present invention configures a magnetic flux converging (bending) device 180 at the front end or near field of the transmitting coils 120. The magnetic flux converging device 180 may adjust the medium from positive to zero or negative refractive index or zero refraction to improve the directionality of the coil magnetic flux, thereby lengthening the charging distance. The present invention discloses zero or negative refractive index mediums configurated at the front end of the transmitting coils 120, please refer to FIG. 3. In other embodiments, it can be partially covered or placed in the near field. In another embodiment, the magnetic flux converging device 180 with a continuous S-shaped pattern structure can be used in the transmitting coil 120 to improve the transmission distance. Refer to FIG. 4, it shows the top view. The magnetic flux converging device 180 is configurated in the radiation direction of the transmitting coils 120, the side efficiency can also be improved.

The magnetic flux converging device 180 is a periodic combination of plural units. The cell size is smaller than the wavelength of the applied electromagnetic radiation. In other words, at least one of negative permeability and negative permittivity materials is used for the magnetic flux converging device 180 in the present invention. Examples of cell patterns include a certain length of wire, a wire with a loop (or loops), a coil, or multiple wires with loops, other examples include resonators based on spiral patterns. The sub-wavelength resonant rings are placed in opposite directions to each other to adjust the magnetic permeability. In order to generate resonance and enhance the magnetic response, a capacitor is introduced. Inductors and capacitors work together to form a resonant circuit, and the metal ring is regarded as an inductor. A gap is etched in the ring to create a capacitor, the charges will accumulate at both ends of the gap. The resonant ring is analogous to a resonant circuit. Hardy W N, Whitehead L A proposed that ring resonators could be used for magnetic resonance in 1981.

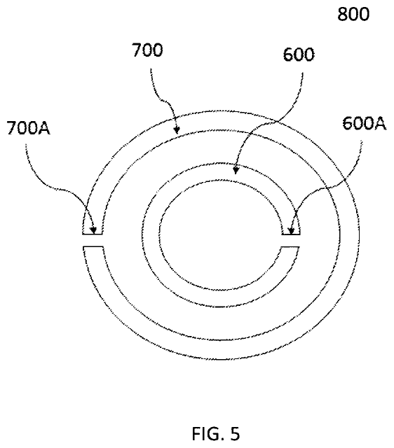

Negative permittivity or/and permeability can be obtained by controlling the resonance of the medium (material). Resonance means that the material will tend to vibrate at a specific frequency. The resonance circle is used to simulate the electromagnetic reaction. The size of the resonance unit has to match with the wavelength of the electromagnetic wave. Resonant units such as split ring resonators can interact with electromagnetic waves. A split-ring resonator is an artificially produced structure common to metamaterials. Its purpose is to produce the desired magnetic response. The split-ring resonator could be rectangular, triangular or circular rings. The medium composed of the split ring resonator array generates strong magnetic coupling with the electromagnetic field, which is a characteristic that traditional materials do not have. For example, the periodic split ring resonator array will produce negative permeability and other effects. Referring to FIG. 5, each individual split ring resonator 800 is composed of a pair of concentric metallic rings 600 and 700, etched on the dielectric substrate, with slits etched on opposite sides. The rings 600 and 700 have slits 600A and 700A at both ends. The rings 600 and 700 are made of non-magnetic metals such as copper and silver, with a small gap between the ring loops. A magnetic flux penetrating the metal rings will induce rotating currents in the rings, which produce their own flux to enhance or oppose the incident field. This field pattern is dipolar. The rings can be concentric or square, with gaps set as needed, and the magnetic flux penetrating the metal ring will produce the dipole pattern of electromagnetic fields in the ring.

The small gaps between the rings produces large capacitance values which lowers the resonating frequency. Hence the dimensions of the structure are small compared to the resonant wavelength. This results in low radiative losses and very high-quality factors. In one embodiment, the radius of the split ring resonator is related to the wavelength of the electromagnetic wave. The split ring resonators can be created using semiconductor micro-or nano-fabrication techniques, direct laser or electron beam lithography depending on the resolution required. For example, the terahertz band frequency, which is typically defined as 0.1 to 10 THz, is located at the end of the infrared band, just after the end of the microwave band. This corresponds to millimeter and submillimeter wavelengths between 3 mm (EHF band) and 0.03 mm (long wavelength edge of far-infrared light); for microwave radiation, the structure dimensions are of the order of millimeters.

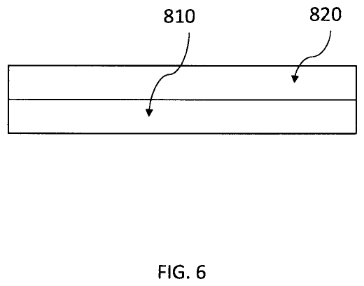

In one embodiment, the split ring resonator 800 is composed of a pair of concentric metal rings formed on the dielectric substrate, with slits 600A, 700A etched on opposite sides, see FIG. 5. It can be implemented by semiconductor photolithography processes, printed circuit processes, or electroplating processes. The main purpose of the split ring resonator is to produce negative or zero permeability medium (material). When the split ring resonator array is excited by a time-varying magnetic field, the structure behaves like an equivalent permeability medium with negative values. Split ring resonators can be used to increase the transmission distance of near-field waves. The split ring resonators exhibit resonant electric response in addition to resonant magnetic response. The response is averaged over the composite structure when it combined with an array of wires, which results in effective values, including the refractive index. Referring to FIG. 6, the split ring resonator array layer 810 and the wire array layer 820 can be fabricated on different layers and similar multiple layers are stacked in sequence, depending on the needs and performance. This is a two-dimensional array; three-dimensional array can also be fabricated.

Traditionally, miniaturization is mainly achieved by introducing the capacitance or inductance on the radiator. The traditional design cannot meet the requirements of directivity, size reduction or wider bandwidth at the same time. The present invention utilizes negative permeability (or/and negative permittivity) medium (material) to improve coil performance. The present invention can also be applied to the receiving end, where the coupling of the system is enhanced by the magnetic flux converging device 180 which is configurated to the receiving coil. In some cases, the magnetic flux converging device 180 is configured with a receiving coil to receive energy. The traditional divergence magnetic field could be bent and converged by the magnetic flux converging device 180. Therefore, the present invention has better effects. The magnetic flux converging device 180 may be arranged in front of the coil at the receiving end.

In another embodiment, the magnetic flux converging device 180 can be shaped as a spherical shell part, and the shell is made of a material with zero or negative refractive index. In another embodiment, the shell is a multi-layer structure, each layer is equidistant and consists of the medium with zero or negative refractive index. The magnetic flux converging device 180 can be configured correspondingly to the transmitting coil, the receiving coil or both.

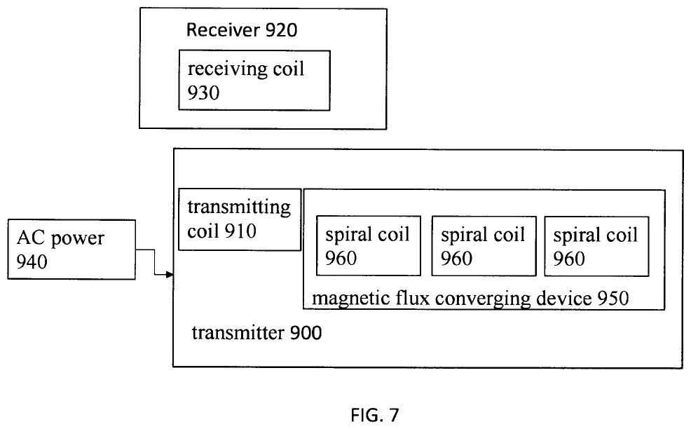

In another embodiment, it can be employed for charging mobile devices or electric vehicles. Referring to FIG. 7, in addition to having the components of FIG. 1 (the redundancy description is omitted), the embodiment is for the transmitter 900. The transmitter 900 has a transmitting coil 910, which has N turns (N is a natural number), and is coupled to the AC power supply 940. The transmitter 900 matches the corresponding transmitting capacitance and resistance, and the receiver 920 has a receiving coil 930, which is wirelessly corresponding to the transmitter 900 and the receiver 920. The receiver 920 matches the corresponding receiving capacitor and resistor. The magnetic flux converging device 950 includes the negative or zero refractive index material, which is mainly used to improve the magnetic flux directionality of the coil, thereby extending the charging distance and achieving wireless charging effect. The magnetic flux converging device 950 is excited to generate resonance, and the resonance frequency is related to the wavelength. The purpose of resonance is to generate a negative permeability. When the resonance is excited by the magnetic field, the structure behaves like a medium with negative or zero permeability. The magnetic flux converging device 950 can be used to converge the magnetic flux so that the coil generates the uniform magnetic field and increases the transmission distance and efficiency.

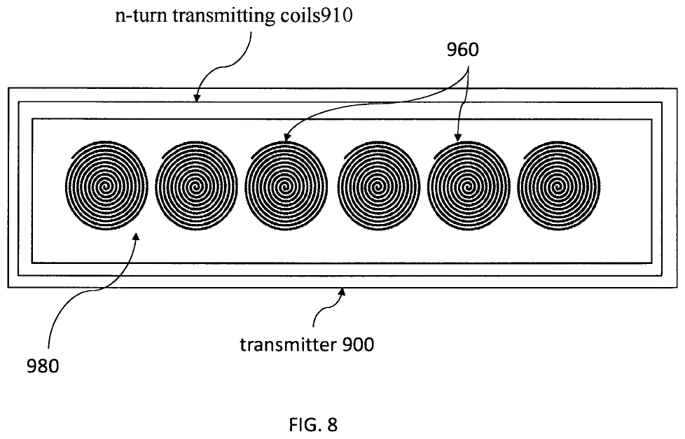

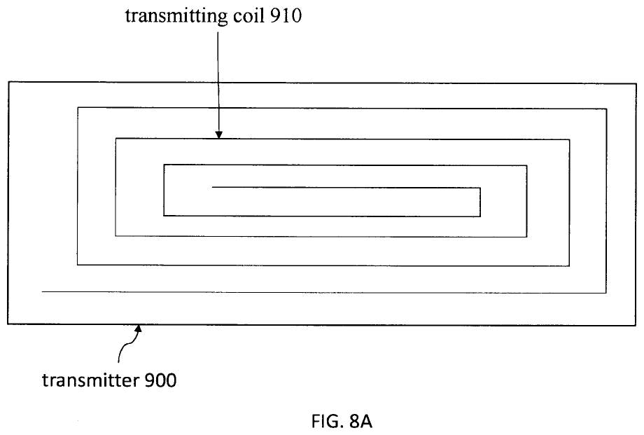

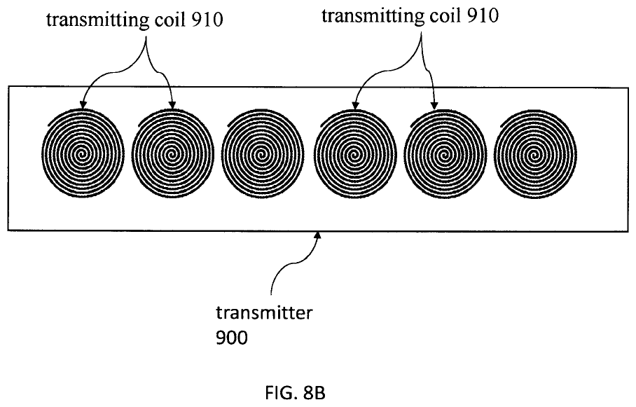

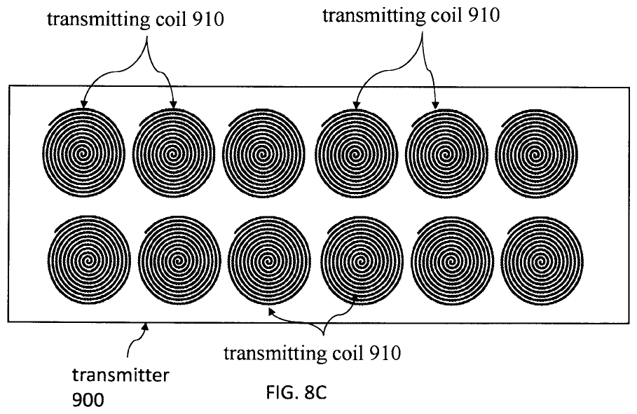

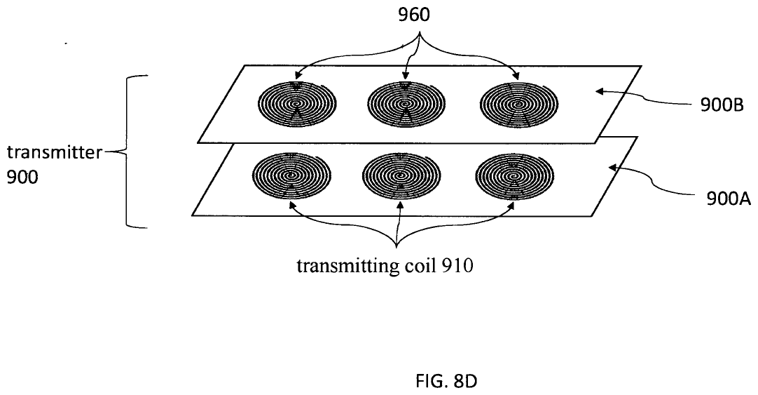

Referring to FIG. 8, the magnetic flux converging device 950 includes a plurality of resonators (or units) made on the substrate. The resonator can be a spiral coil 960 or the aforementioned resonant ring. It must be noted that there are multiple resonators (spiral coil 960) and none of them is connected to power (passive configuration). The spiral coil 960 is used as a resonator and is arranged beside or inside the transmitter coil 910. For example, FIG. 8 shows the top view. The N-turns transmitting coil 910 forms rectangle or square shapes, and the spiral coils 960 are arranged inside the transmitting coil 910 and linearly arranged along the long side of the transmitter coil 910. The system is excited by a transmitter coil 910 to transfer energy. Because of the longer transmission distance, the magnetic coupling between the transmission coils can be ignored. In addition, the aforementioned split ring resonator array can replace the spiral coil 960 array in this embodiment, depending on the requirements. An optional filling material 980 is filled between the coil 910 and the resonator 960 to protect and fix the resonator 960, and the filling material 980 is not only dustproof but also waterproof. The material is selected from resin, fiberglass, plastic, plastic steel or rubber, etc.

Referring to FIG. 8A, the transmitting coil 910 is not wrapped on the four sides of the substrate of the transmitter 900, but is disposed on the surface of the rectangular or square substrate of the transmitter 900. The N-turns transmitting coil 910 includes rectangular or square coils. The transmitting coil 910 arranged on the four sides the planar rectangular or square coils are periodically arranged on the surface of the substrate, which can generate a relatively uniform magnetic field. The magnetic flux converging device 950 further achieves the effect of converging parallel magnetic fields to increase transmission efficiency and distance. Although FIG. 8A shows the rectangular coils, an array of multiple rectangular or square coils can be used instead of a single coil.

Referring to FIG. 8B, a row of transmitting coils 910 is arranged on the rectangular or square substrate of the transmitter 900, and the transmitting coil 910 is a planar spiral coil. Referring to FIG. 8C, the plurality of transmitting coils 910 form a planar spiral coil array, and the plurality of transmitting coils 910 are arranged on the substrate of the transmitter 900.

Referring to FIG. 8D, the transmitting coil 910 is arranged on the first substrate 900A, and the resonator 960 is arranged on the second substrate 900B, thereby forming a stacked structure. The transmitting coil 910 and the resonator 960 are both planar spiral coils. If they have the same structure and size, the manufacturing cost can be reduced. The transmitting coil 910 must be electrically coupled to the power supply, but the resonator 960 shall not be connected to the power supply. In other words, the transmitting coil 910 is in an active configuration, and the resonator 960 is in a passive configuration. Similarly, a plurality of transmitting coils 910 may form an array and be disposed on the first substrate 900A, and a plurality of resonators 960 may form an array and be disposed on the second substrate 900B.

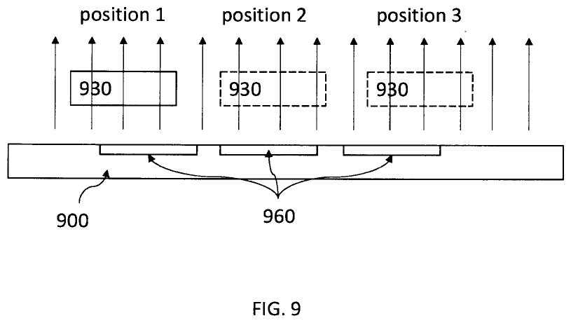

Referring to FIG. 9, based on the magnetic flux converging device 950 (or spiral coil 960) acting as a resonator, the magnetic flux distribution in the transmitting coil 910 is uniformed (indicated by the upward arrow in the figure), therefore, the location arrangement of the receiving coil 930 is flexible. The position is configured at position 1, position 2 or position 3, all have identical receiving performances. Compared with the traditional divergent coils, the transmitting alignment tolerance of the present invention is high, and the energy transmission performance is better. Similarly, the split ring resonant array can replace the spiral coil 960 in this embodiment as the resonator.

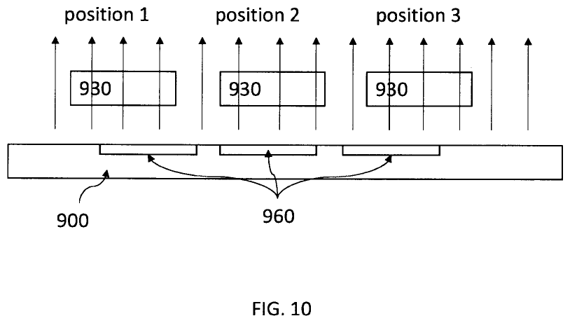

Referring to FIG. 10, based on the magnetic flux distribution is uniform in the transmitting coil 910, one embodiment of the present invention is to configure a plurality of receiving coils 930 over the top of the transmitting coil 910 in line. For example, three receiving coils 930 are located at positions 1, 2 and 3 for receiving energy at the same time, thereby improving the charging efficiency by at least three times. The number and the location of the three receiving coils are illustrated only for examples and are not intended to limit the present invention. Ideally, any number receiving coils 930 can be applied. The plurality of receiving coils 930 mentioned above can be installed in one device or multiple devices. For one device, the charging efficiency can be improved; for multiple devices, the purpose of charging multiple targets can be achieved, simultaneously.

The magnetic flux convergence device (or resonator array) 950 is arranged at the front end or near field (such as inside) of the transmitter coil 910, the resonator array 950 resonates based on the magnetic field of the transmitter coil 910, thereby changing the refractive index of the transmission medium. The medium between the transmitting and receiving ends are transformed into the zero or negative refractive index medium to enhance the system magnetic field, which overcomes the limitations and increase the transmission distance to improve the wireless charging efficiency. Typically, the transmitting coil 910 determines the power transfer level, efficiency and overall performance of the system. In one embodiment, the operating frequency of the transmitter 900 (or the transmitting coil 910) is 10 kHz to 40 MHz, and the power is 3 kW-22 kW. In one embodiment, the operating frequency of the transmitter 900 (or transmitting coil 910) is 20 kHz. The spiral coil 960 includes a spiral winding with an outer diameter of 1-50 cm. The distance between each unit of the spiral coil is 0.5-10 cm, depending on the needs. In one embodiment, the spiral winding outer and inner diameters are 8 cm and 2 cm, respectively, the cell spacing is 2 cm, and the effective inductance and capacitance are 140 μH and 0.47 μF, respectively.

Ideally, the spiral coil design with negative or zero permeability affects the flux density toward the receiving coil. For example, the quality factor Q=ωL/R. To improve Q, enameled (magnet) wire can be used in the coil, by adjusting the inductance value and resistance value of the spiral coil 960, the quality factor is changed. If the radius of the spiral coil 960 is R, and the distance between adjacent spiral coils 960 is d, the ratio d/R is preferably less than 10%.

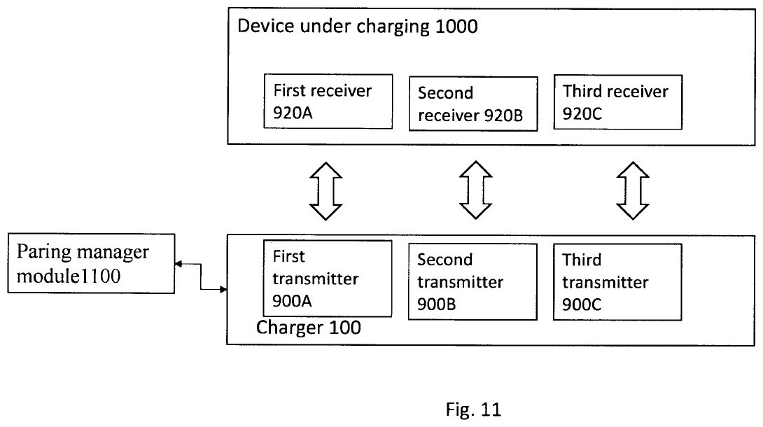

FIG. 11 shows that the first transmitters 900A, the second transmitters 900B, and the third transmitters 900C are configurated in the charging device 100, corresponding to the first receiver 920A, the second receiver 920B, the third receiver 920C configured in the device 1000 to be charged. In this way, multiple wireless charging pairs can be implemented at the same time, and multiple transmitting/receiving pairs can be employed for charging simultaneously to shorten the charging time of the device to be charged, especially in the field of electric vehicles. Before pairing, each set of transmitters and receivers respectively transmit pairing information, followed by performing pairing procedure by the smart pairing management module 1100. In another embodiment, the first receiver 920A, the second receiver 920B, and the third receiver 920C can also be respectively configured in three different devices to be charged 1000 to implement the procedure of charging multiple objects, simultaneously.

In one embodiment, the resonator array and the coil circuit are fabricated on a printed circuit board or a flexible board. For example, the printed circuit board includes at least one layer of printed coil circuits, or multi-layer stacked printed coil circuits, layers between layers are connected through holes. Resonator arrays, such as repeating periodic spiral conductor patterns or split ring resonators, can also be prepared on printed circuit boards or flexible boards. Multi-layer resonator arrays can be made by stacking to create two-dimensional or three-dimensional structures array. For example, the flexible board has multiple resonator patterns, in one example, the coil circuit and the resonator array can be printed on the same layer. In addition to printed circuit boards, other material could be employed for the substrates, the material includes but not limited to plastic, fiberglass, semiconductor dielectric, insulating dielectric, quartz, silicon dioxide, sapphire or glass.

The resonator may include part or all of shapes such as straight lines, circles, squares, rectangles, triangles, spirals, etc., and it may include openings.

If it is a wireless charging coils, the wireless charging operating frequency range is between 20 kHz and 30 MHz, and the power is between 3.3 and 22kw, then the size of the ring resonator or spiral coil is approximately centimeter level. In one embodiment, the size of the resonator or spiral coil unit is approximately between 1 cm and 20 cm for generating a resonant frequency.

In one embodiment, the above-mentioned resonator can be applied to the transmitting coil to form a stacked structure. The transmitting coil can be a planar spiral coil, which is connected to the power supply and is an active configuration. The resonator is planar spiral coils which are not connected to the power supply, it is a passive configuration. If the shape and dimension of the transmitting coil and the resonators is the same, it may simplify the coil manufacturing process and cost.

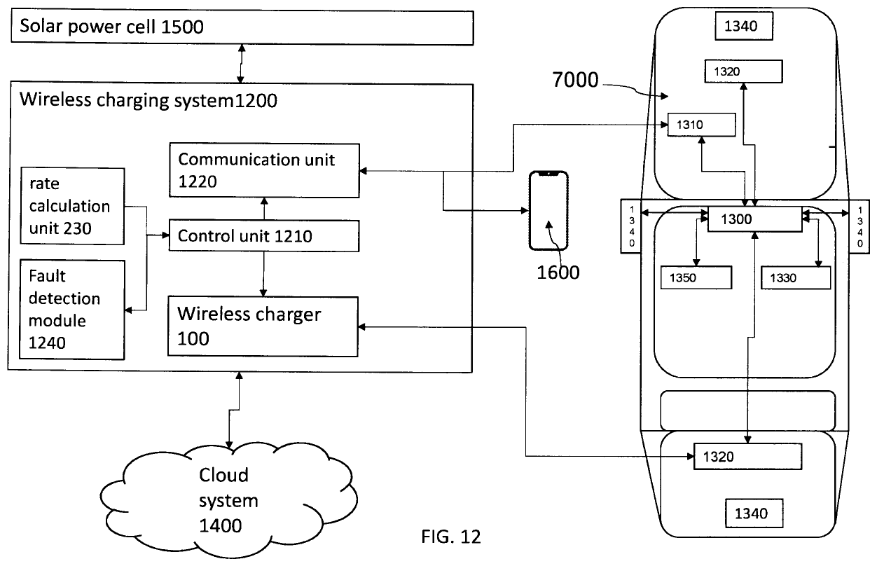

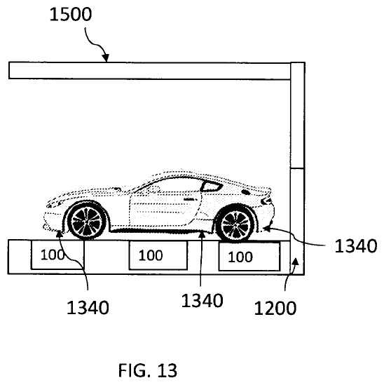

Referring to FIGS. 12 and 13, the present invention proposes a wireless charging system 1200, which includes a control unit 1210, a wireless charging device 100, and a wireless communication unit 1220, these units are electrically connected to the control unit 1210. The rate calculation unit 1230 and the fault detection module 1240 are electrically connected to the control unit 1210 as well. The commercial power or solar power source 1500 is electrically connected to the wireless charging system 1200 to provide the required power. The wireless communication unit 1220 may include one of short-range, long-range, or low-orbit satellite communication modules, or any combination of the above. The short-range communication module mainly communicates with the wireless communication module 1310 in the vehicle 7000 by two directions, and it can be used as a pairing tool between the vehicle 7000 and the wireless charging system 1200 to exchange information, authentication, login, payment and other procedures. When the pairing is completed and successful, the charging process is initiated through the charging management module 1350 coupled to the controller 1300 in the vehicle 7000. In this situation, the user does not need to get out of the car to operate the wireless charging system 1200. The charging management module 1350 is also configured in the wireless charging system 1200. In this case, the user must get out of the car to operate the wireless charging system 1200. In another embodiment, the charging management module 1350 can also be configured in the user's smartphone 1600. In this case, the user operates the wireless charging system 1200 without getting out of the car.

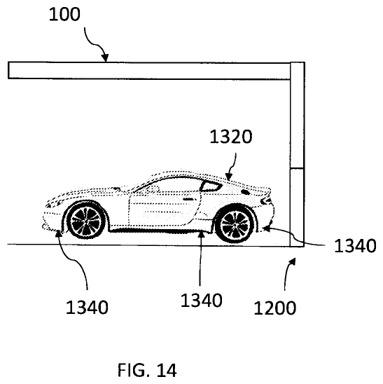

In another embodiment, refer to FIG. 13, the wireless charging device 100 of the present invention is arranged on the ground or under the ground, while the receiving coil of the electric vehicle is arranged below the vehicle. In another embodiment, refer to FIG. 14, the wireless charging device 100 is arranged over the electric vehicle, such as on the ceiling or cover, and the receiving coil of the electric vehicle must be arranged on top of the vehicle. In another embodiment, the wireless charging device 100 is disposed below the solar power source 1500 and is coupled to the solar power source 1500.

In another embodiment, the transmitter drives the coil with alternating current, and the corresponding alternating current is induced in the receiver coil according to Faraday's induction law. By adjusting the current of the transmitter coil and the load of the receiver coil, the transmitter and receiver respectively encode data to exchange information. In this embodiment, the transmitter not only transmits power, but also information, thereby eliminating the need for a wireless communication unit 1220. In this embodiment, the wireless transmitter must be coupled to the codec, and similarly, the wireless receiver must be coupled to the codec. Therefore, before charging, information is exchanged between the transmitting coil of the wireless charging device 100 and the receiver of the vehicle 7000. The transmitting coil of the wireless charging device 100 and the receiver of the vehicle 7000 communicate bidirectionally when the link between the vehicle 7000 and the wireless charging system 1200 is established. The users may exchange information, authenticate, login, and pay when the pairing is completed. When the charging process is initiated, the user operates the wireless charging system 1200 without getting out of the car.

The vehicle 7000 includes at least one alignment device 1340 for aligning with the wireless charger alignment device 110 of the wireless charging system 1200. The alignment device 1340 can be an image capture device, an infrared transmitter, a radar, or a lidar. The wireless charger alignment (positioning) device can be a signal receiver, an infrared receiver, a radar receiver, a lidar receiver or a barcode, a mark or a QR CODE. In one embodiment, the wireless charger alignment (positioning) device can be disposed on the wall or on the ground to provide positioning or alignment for the alignment device 1340. In one embodiment, the wireless charger alignment device is disposed on the ground and is the barcode, the mark or the QR CODE for the alignment device 1340 to capture images for alignment. The alignment device 1340 is an image capture device, such as a camera installed on the underside or chassis of the car. The wireless power receiver 1320 is disposed on the bottom side of the vehicle 7000, such as the bottom side of the front end or rear end of the receiving end. The upper side of the wireless power receiver 1320 contains an electromagnetic shielding device, such as a Faraday cage, to prevent electromagnetic waves from entering the vehicle.

The vehicle 7000 includes a payment tool 1330, which is electrically connected to the control unit 1210 and is used to pay the charging fee. After the rate calculation unit 1230 calculates the charging fee, the charging amount is calculated. In this situation, the user does not need to get out of the car to operate the wireless charging system 1200 for payment. The payment tool can also be configured in the wireless charging system 1200. In this case, the user must get out of the car to operate the wireless charging system 1200. In another embodiment, the payment tool 1330 can also be configured in the user's smartphone 1600. In this case, the user can operate the wireless charging system 1200 without getting out of the car. The cloud management system 1400 is wired or wirelessly connected to the wireless charging system 1200, and receives information, including transactions, vehicle identification, charging time, rates, etc., as well as health diagnosis status, from the wireless charging system 1200. The fault detection module 1240 can detect the health status of the vehicle battery and also detect whether there is a fault in the wireless charging system 1200 itself.

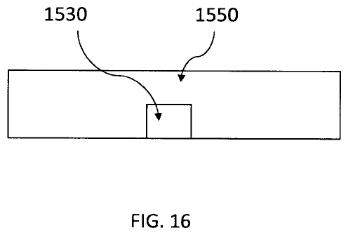

In another aspect of the present invention, the antenna usually is configurated on the motherboard or frame of the mobile phone. The antenna on the motherboard will occupy space, which is not conducive to make it thinner. The FPC (Flexible Printed Circuit) is like an internal part. The disadvantage is that it occupies the space of the main body, and the outer frame of the phone is occupied by too many antennas. The metal frame antenna design mainly uses the metal frame as part of the antenna for radiation. Generally, the types of the antennas are: IFA, Monopole, and Loop. Depending on the functionality and satellite communication requirements, the space for the frame antenna will be limited. In addition to multiple frequency bands for mobile communications such as 2G, 3G, 4G, 5G and 6G, other communications such as Bluetooth and Wi-Fi require multiple different antenna designs. Most mobile phone manufacturers divide the metal frame into multiple parts to meet the needs of different sizes and antenna placements. Considering the working efficiency of 5G or more advanced versions such as 6G mobile phone antennas, the isolation between MIMO antennas must be improved. Traditional isolation measures include increasing the physical distance between antennas or changing the location of the antennas. If the antenna of the present invention is made on the rear shell, it has many space advantages compared with the frame, it may also improve the isolation between antenna units. Refer to FIG. 16, the antenna 1530 of the present invention introduces a negative refractive index or zero refractive index medium 1550, reducing mutual coupling effects between antennas. In the present invention, the negative or zero refractive index refractive index medium 1550 is arranged in the antenna radiation direction, and it can completely cover, or partially cover the antenna 1530, alternatively, it may be placed nearby the antenna.

In another embodiment, a medium with a continuous S-shaped pattern structure can be disposed on the antenna 1530 to improve the antenna gain. Disposing these materials on the frame in the radiation direction of the antenna also improves the efficiency of the frame antenna. The resonant unit interacts with the electromagnetic waves to induce current, and the periodic ring resonator array generates strong magnetic coupling with the electromagnetic field, producing negative permeability and other effects. The magnetic flux penetrating the metal ring will induce a current in the ring, thereby producing a dipole pattern of electromagnetic fields. Compared to the resonant wavelength, the small size of the structure results in low radiation losses and high-quality factor. In one embodiment, in an electrically small single dipole antenna, the electromagnetic wave frequency is 2.025 GHz, the radome radius can be wavelength/18.5, the impedance is 50 ohms, and the VSWR is less than 1.02.

Therefore, the present invention is employed to smart phones or tablets for converging microwaves emitted or received by antennas. With the demand for satellite communications in the future, the number of mobile phone antennas will be increased. For the purpose of the present invention, some mobile phone antenna may be formed on the back panel space of the mobile phone without increasing the thickness.

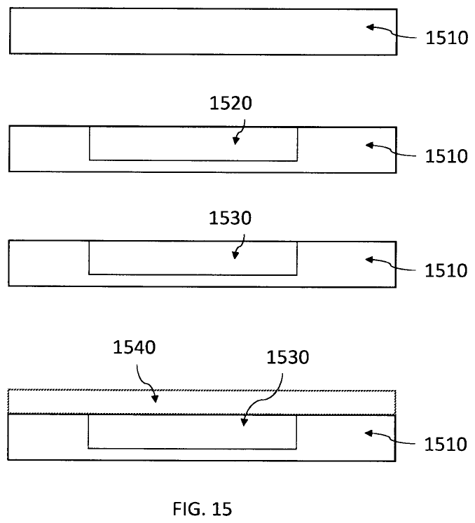

Wireless radio frequency signals cannot pass through metal materials, but can directly pass through plastic and ceramic materials. Referring to FIG. 15, the present invention provides a substrate 1510, which is formed of glass, plastic, ceramic, etc. A laser beam is used to accurately scan the specific antenna area 1520 on the substrate 1510, and the antenna pattern 1530 is metallized by chemical plating to form a conductive structure, thereby increasing the freedom degree of antenna design. The design cycle can be shortened, the design is highly efficient and flexible, in addition, the circuit design can be temporarily changed. The thickness of the optimal antenna line 1500 does not exceed the surface of the substrate 1510. In addition to providing an antenna, the present invention does not occupy space. The antenna area 1520 is an inward-facing or outward-facing surface.

Preliminary laser activation treatment is required on the surface of the substrate to make it easier for metal adhesion. Laser activation is used to initiate a chemical reaction, thereby forming quite fine metal particles on the surface. In addition to forming fine metal particles, the laser-activated surface also forms a rough surface. Therefore, during the metallization process, it is benefit for the copper or other metals to adhere on the treated surfaces. Metallization (electroless plating) is the process of forming metal on a surface. Electroless plating leaves a layer of copper (or other metal) on the laser-treated surface area to form the desired antenna pattern. Later, electroplating was often used to increase the thickness of the metal layer to improve the electronic properties of the antenna.

Combined with processes such as laser engraving and electroplating, metal circuits are formed on the base material 1510. The base material 1510 for carrying the antenna 1530 can be made of plastic, such as ABS+PC, PC and other materials are available from the market. The circuits can also be made on ceramics or glass rear shell to enhance the competitive advantage of antenna products. In one embodiment, the antenna is printed or coated on the substrate 1510. Finally, a protective layer 1540 is added on the surfaces of the antenna 1530 and the substrate 1510. The protective layer 1540 is made of the same material or different material. In order not to increase the thickness of the rear shell, the substrate 1510 is polished before the laser light is scanned and etched. If the protective layer 1540 is made of the same material, the antenna is buried in the rear shell. In one embodiment, the transparent conductive material is used as the antenna material, so the metallization process includes step of forming conductive polymers, indium tin oxide, carbon nanotubes, and the like in the antenna area 1520.

The present invention discloses a smart phone including a front panel framed by a frame, and the frame has at least one frame antenna; the rear shell is configured opposite to the front display, and the rear shell has at least one rear shell antenna, wherein the rear shell antenna is formed on the rear shell base material; the rear shell antenna is formed by laser to form an antenna pattern area on the rear shell base material, and the metallization is employed to form the rear shell antenna in the pattern area, where the metallization includes chemical plating, the above is called laser metallization process. Smartphone rear shell substrate includes glass, ceramics, and plastics, and rear shell antennas include Bluetooth, WiFi, NFC, 5G, 6G, GPS, low-orbit satellite antennas, or any combination of the above. In addition, coils made on the rear shell is used for signal transmission, such as NFC or wireless charging coils.

In one embodiment, in addition to the above-mentioned smart phone rear shell antenna, the rear shell antenna is formed on the rear shell substrate using three-dimensional printing, and the rear shell antenna is located within the rear shell substrate or does not exceed its surface. The rear shell, the frame, or both contains materials with negative or zero refractive index, preferably, the rear shell, the frame or both includes composite materials having these properties. The negative or zero refractive index materials contain an array of split ring resonators, where each ring resonator is paired with a straight wire. In one embodiment, the spiral coil may be used instead of the ring resonator. If it is a microwave antenna, the size of the ring resonator or spiral coil is about millimeters.

In one embodiment, the above-mentioned spiral coil or ring resonator is made on a detachable mobile phone protective case, regardless of the inside or outside. Therefore, to provide an additional microwave convergence device for a smartphone or tablet, the manufacturing method is the same as shown in FIG. 15.

In the above embodiments, it is better to use a planar spiral coil as the resonator. Compared with the ring resonator, the main advantage is that the spiral coil can avoid anisotropic effects, and the continuous coil composed of spiral coil medium is relatively easy to manufacture. If the sizes of the resonator units are the same, assuming C0 is the resonant capacitance value, the equivalent capacitance of the ring resonator is about one-quarter C0, the equivalent capacitance of the two-turn spiral coil is about C0, and the equivalent capacitance of the three-turn spiral coil is about 2C0, and so on. The resonant size of the outer ring resonator is approximately twice that of the two-turn spiral coil, which can significantly reduce the electrical size of each resonator unit compared to the ring resonator. Spiral coils can be manufactured using relatively inexpensive techniques such as printed circuit boards or photolithography.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A wireless charging device, comprising:
at least one transmitting coil connected to a power supply; and
at least one resonant coil configurated in front of said at least one transmitting coil to form a negative or zero refractive index medium by resonance; wherein said at least one transmitting coil includes a first spiral coil.

2. The wireless charging device of claim 1, wherein said at least one resonant coil includes a second spiral coil.

3. The wireless charging device claim 2, wherein said at least one resonant coil includes a spiral winding outer diameter of 1-50 cm.

4. The wireless charging device of claim 3, wherein a distance between each unit of said second spiral coil is 0.5-10 cm.

5. The wireless charging device of claim 3, wherein said spiral winding outer diameter is 8 cm.

6. The wireless charging device of claim 3, wherein a spiral winding inner diameter is 2 cm.

7. The wireless charging device of claim 2, wherein a radius of said second spiral coil is R, a distance between adjacent second spiral coil is d, a ratio d/R is less than 10%.

8. The wireless charging device of claim 1, wherein said at least one transmitting coil wirelessly transmits energy or information to an electric vehicle.

9. The wireless charging device of claim 8, wherein said electric vehicle includes at least one vehicle resonant coil configurated in front of a vehicle receiving coil.

10. A wireless charging device, comprising:
at least one transmitting coil connected to a power supply; and
at least one resonant coil configurated in front of said at least one transmitting coil to form a negative or zero refractive index medium by resonance, said at least one transmitting coil including a first spiral coil, said at least one resonant coil including a second spiral coil.

11. The wireless charging device of claim 10, wherein said at least one resonant coil is identical to said at least one transmitting coil.

12. The wireless charging device claim 10, wherein said second spiral coil includes a spiral winding having an outer diameter of 1-50 cm.

13. The wireless charging device of claim 10, wherein a distance between each unit of said second spiral coil is 0.5-10 cm.

14. The wireless charging device of claim 10, wherein a winding outer diameter of said second spiral coil is 8 cm.

15. The wireless charging device of claim 10, wherein a winding inner diameter of said second spiral coil is 2 cm.

16. A wireless charging device, comprising:
a wireless communication device configurated in said wireless charging device to communicate with an electric vehicle;
at least one transmitting coil connected to a power supply to wirelessly charge said electric vehicle; and
at least one resonant coil configurated in front of said at least one transmitting coil to form a negative or zero refractive index medium by resonance.

17. The wireless charging device claim 16, wherein said at least one resonant coil includes a spiral winding having an outer diameter of 1-50 cm.

18. The wireless charging device of claim 16, wherein said at least one resonant coil includes a spiral winding outer diameter of said second spiral coil is 8 cm and a spiral winding inner diameter is 2 cm.

19. The wireless charging device of claim 16, further comprising at least one alignment device for aligning with said electric vehicle.

20. The wireless charging device of claim 19, wherein said at least one alignment device includes a signal receiver, an infrared receiver, a radar, a lidar receiver, a barcode, a mark or a QR CODE.
